(19) United States
(12) Patent Application Publication
(10) Pub. No.: US 2015/0066787 A1
(43) Pub. Date: Mar. 5, 2015

(54) REAL ESTATE MANAGEMENT SYSTEM

(71) Applicant: Tommy JEDRZEJCZYK, Portland, OR (US)

(72) Inventor: Tommy JEDRZEJCZYK, Portland, OR (US)

(21) Appl. No.: 14/301,104

(22) Filed: Jun. 10, 2014

Related U.S. Application Data
(60) Provisional application No. 61/833,264, filed on Jun. 10, 2013.

(51) Int. Cl. G06Q 50/16; G06F 3/0484; G06Q 10/10

(52) U.S. Cl. CPC G06Q 50/163; G06Q 10/10; G06F 3/04842
USPC 705/314

(57) ABSTRACT

A system for the management of real estate.

### CROSS-REFERENCE TO RELATED APPLICATIONS

This application claims the benefit of U.S. Provisional App. No. 61/833,264, filed Jun. 10, 2013.

### BACKGROUND OF THE INVENTION

The present invention relates to a real estate management system.

A real estate agent works on behalf of a client to help identify potential properties, such as houses, that may be of interest to the particular client. After doing a search through paper property records, Internet available records, or otherwise through real estate related databases, the home buyer identifies a set of properties that may be of interest. Often after a consultation with the client, the real estate agent reviews the address of each of the properties together with contacting the listing agent (or owner of each property) to determine an order for viewing, together with when to view, the properties to reduce the amount of time involved in viewing the properties. In this manner, the real estate agent and his client reduce the amount of zig-zag driving around town looking at the identified properties. While such a process for the showing of houses to potential home buyers is functional, it requires the real estate agent to spend considerable time and energy in preparing for each showing of multiple houses.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a network for virtual tours.

FIG. 2 illustrates an interface for scheduling options.

FIG. 3 illustrates a confirmation screen.

FIG. 4 illustrates an interface with property info options.

FIG. 5 illustrates an interface with photo options.

FIG. 6 illustrates an interface with history options.

FIG. 7 illustrates an interface with client notes options.

FIG. 8 illustrates an interface with agent notes options.

FIG. 9 illustrates an interface with walk score options.

FIG. 10 illustrates an interface with schools options.

FIG. 11 illustrates an interface with payment options.

### DETAILED DESCRIPTION OF PREFERRED EMBODIMENT

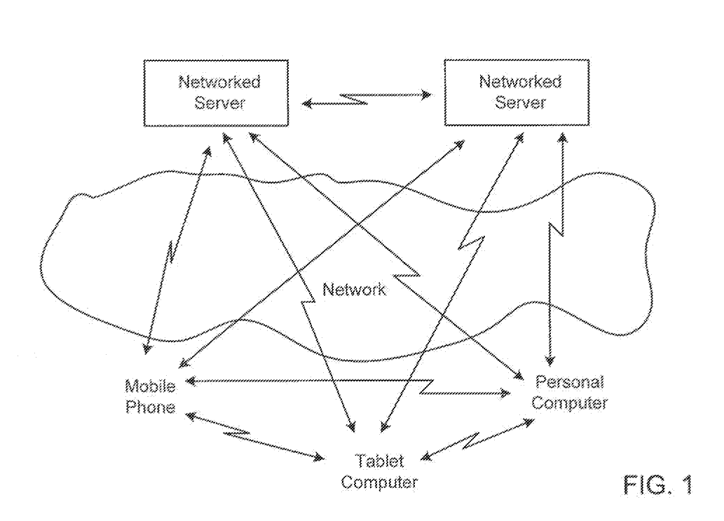

Referring to FIG. 1, a software application may be made available to the real estate agent and/or the client (e.g., buyer) through software installed on his personal computer (e.g., computing device), through a network interface available to the computing device, through software running on a networked server (e.g., available through a browser on a computing device), through an application running on a tablet, through an application running on a mobile phone, and/or any computing device that may or may not be networked that runs the software locally or access software running on a network server, such as though a browser, and/or a combination thereof. Moreover, any of the computing devices may be interconnected with any of the other computing devices, either the same type or a different type.

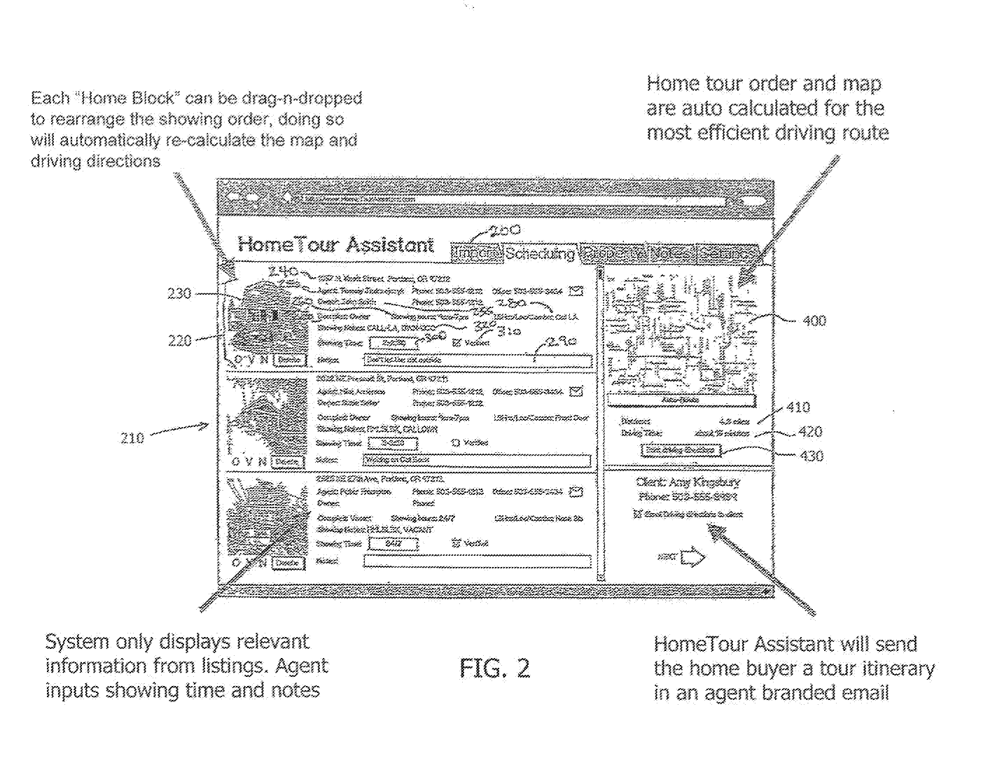

Referring to FIG. 2, the agent may be presented with an assistant interface, such as through a web page accessible on a network such as the Internet or otherwise available locally running on his computing device, to assist with the selling of homes to potential buyers. The assistant interface may include an import tab 200 that facilitates the importation of desirable homes into the assistant interface. The importation may include the ability to import data regarding homes from a variety of different sources. For example, an importation option may be to import a selection of houses from an on-line “public” real estate listing service, such as Zillow or Trulia. For example, an importation option may be to import a selection of houses from an on-line “private” real estate listing service, such as one or more multiple listing services, each of which has information regarding one or more homes. For example, an importation option may be to import a selection of houses from other data stored by the particular agent available from a computing system relating to other potential buyers of the agent. For example, an importation option may be included to import data regarding a selection of houses from other data sources, where the importation characteristics for the other data source may be configurable by the agent. In any event, the agent may import data regarding one or more houses from any available data source.

Referring again to FIG. 2, a set of houses may be selected by the agent and/or the buyer as those of potential interest to the buyer. These may be imported into the agent interface or otherwise selected on-line in some manner. This provides a set of houses that may be presented in a scheduling interface 210 in a sequential manner, such as one that is scrollable. Each of the properties may be arranged in a rectangular block 220 with relevant information being displayed that is pertinent to the agent and/or the buyer. For simplified identification of the home, such as from the street or recollection of which home the record is associated with, an image 230 of the home may be displayed. The image of the home may further include the ability to scroll through a variety of different images, such as using an automatic scroll function, an arrow selecting the next or previous image, and/or swiping the image on the screen to scroll one direction or the other to another image. By way of example, often the data will be obtained from the MLS system. With the selected properties being known, the agent accesses the MLS system, selects the desired properties, and exports the data for the selected properties to the assistant (preferably as a group with one export process). A window may be presented by the assistant and the MLS numbers for the selected properties may be imported together with associated data. In this manner, the exporting process may be integrated within the MLS system.

For simplified presentation of the home, selected materials from all the potential available data may be presented on the display. The address 240 of the listing may be presented on the display which is useful for locating the home or otherwise identifying the neighborhood in which the home is located. The contact information 250 for the listing agent may be presented, such as listing agent's name, listing agent's agency, listing agent's e-mail, listing agent's cellular phone and/or office phone, so that agent for the buyer may contact the listing agent regarding viewing the home. For the simplified presentation of the home, the owner of the home together with his contact information (e.g., phone and/or e-mail) may be included 255. This provides alternative contacts to the listing agent for scheduling viewing of the home. The home may have limitations on when the home is available for viewing (e.g., showing hours) 260, whether the home is occupied 270, and where the keys for the house are located 280. Upon the buyer's agent contacting the listing agent, there may be particular notes that are passed onto the buyer's agent which may be entered in a notes section 290. Further, upon the buyer's agent contacting the listing agent, the buyer's agent may enter a time and/or day where the home is available for viewing 300. Further, the buyer's agent may select a “verified” 310 selection when the showing time has been confirmed by the seller's agent and/or the showing time has been confirmed by the buyer, or otherwise to indicate that the buyer's agent is interested in viewing the home during the time window indicated.

In normal practice, once a time window for viewing is determined by contacting the relevant parties, if necessary, a time is entered in the showing time box. Alternatively, a show time may be selected using a pull down window or other mechanisms. In some cases, the imported data may include available showing times and/or other data fields. In any event, a time is tentatively confirmed in the showing time window of when the house is confirmed for viewing. Once the time is confirmed, the verified selection may be selected. In this manner, the agent will be able to manage in an easy to see visual manner whether a particular time has been confirmed for viewing. Other showing notes may be included, such as for example, CALL-LA (e.g., call listing agent), OWN-OCC (e.g., owner occupied) 320.

In general, based upon the discussion with the listing agent, owner, buyer, and/or other information obtained, the agent may enter notes into the system. In this manner, the agent does not need to retain stacks of scraps of papers to remember particular things about a particular home, nor attempt to organize the papers in some manner to arrange a suitable order of viewing the homes.

The order of the homes may be re-arranged in the scheduling layout in any suitable manner, such as for example, by dragging and dropping the boxes to create a different order. For example, the homes may be arranged in an order from the earliest showing time to the latest showing time. With the homes arranged in a desired viewing order, an auto-route function 400 may be selected so that the driving directions from the current location (or a selected location such as the meeting location of the buyer's agent and the buyer) may be automatically generated on a graphical road map together with driving directions. The driving directions may further include the total distance to be traveled for all the homes 410, the total drive time for all the homes 420, distance between each of the homes, the driving time between each of the homes, which may be further modified based upon real-time traffic conditions. A larger scale of the map may be printed together with driving directions 430, if desired. In this manner, based upon the order of viewing of the homes included in the scheduling interface 210, an automatic driving and showing plan may be determined. If one or more of the home's order is changed, then the auto-route function 400 may auto-update the map and/or driving directions. By way of example, when a list of homes is imported into the interface, it may use a third party API to provide information on a preferred automatic route of all the properties in an initial optimized order. This initial optimized order is the way the agent will observe them when first opening the web page and/or tab of the interface. Once the agent starts calling to schedule the properties, the agent may change the order by dragging and/or dropping the “property blocks” 220. Also, if the agent and/or client may manually re-arrange the order to accommodate the showing availability of the properties, or perhaps because the agent may have a showing strategy to show a certain house before another, then each time a property block is moved, the map 400 may automatically be updated with the drive time and directions. If an agent has verified a few of the showings in a certain order, then by clicking the auto-route button 400, the system may optimize and/or rearrange the order of any of the properties that have not yet been checked as “verified”. In this manner, all the verified homes will not be similarly changed. As an example, if an agent wanted to show a certain home last, he could drag that home block to the bottom of the list and click verified, then by clicking auto route, all of the other properties would be routed to work with the home that was already verified.

In some embodiments, the time windows that are available for a particular home may be a larger time window, or otherwise substantially more than a shorter time window for another home. In this manner, the system may optimize the driving distance and/or driving time based upon selecting an available time within the available time window(s). Accordingly, the viewing order of houses may not necessarily be the order of the house rectangles are included in the interface, if desired. Preferably, the order of home blocks is the order of showings, which simplifies the process by allowing agents to drag and drop the blocks to arrange the showing order, which in turn updates the driving directions. Moreover, the optimization may include a viewing time for the home in the schedule, such as 30 minutes, to determine the optimal viewing order so that all the homes may be viewed within the available time windows. The viewing time for all and/or each home may likewise be modified by the agent and/or buyer, as desired.

As previously discussed, with a tour itinerary being determined in an efficient manner by an efficient organization of a set of available showing times, a graphical map is provided together with driving directions. In this manner, the agent has an efficient manner of determining the order of the viewing of available home. Further, the client for whom this particular virtual tour was assembled may be sent the virtual tour in a suitable manner, such as an E-mail or link to an on-line tour. The virtual tour may include the graphical map, the driving directions, and/or the home listings. Also, providing the virtual tour to the buyer may be in the form of a branded e-mail.

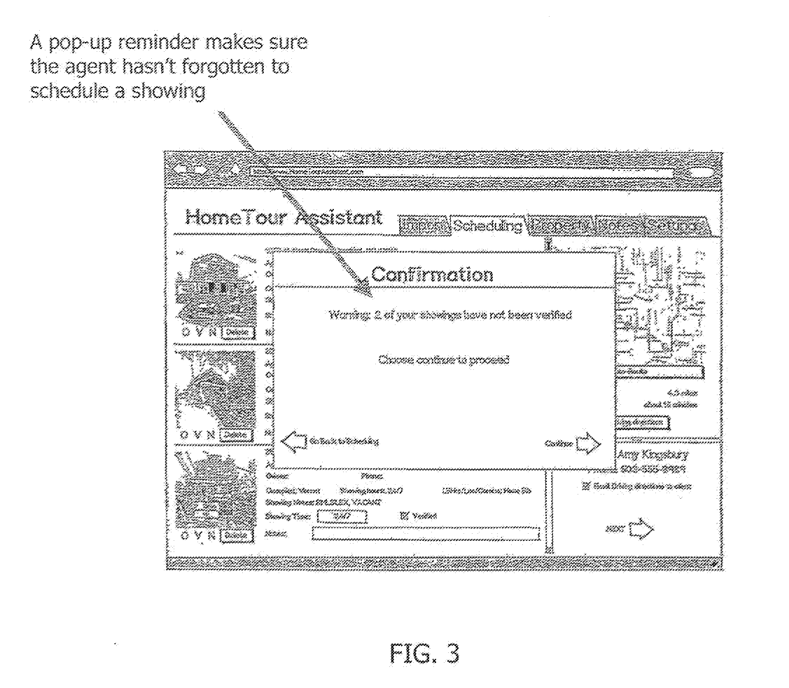

Referring to FIG. 3, to assist the agent in ensuring that he has verified the availability of each of the properties, a confirmation message may be provided if one or more of the listings in the schedule has not been verified when generating a virtual tour (e.g., auto-route and/or driving directions). Upon viewing the confirmation message, the agent may elect to go back to schedule or continue.

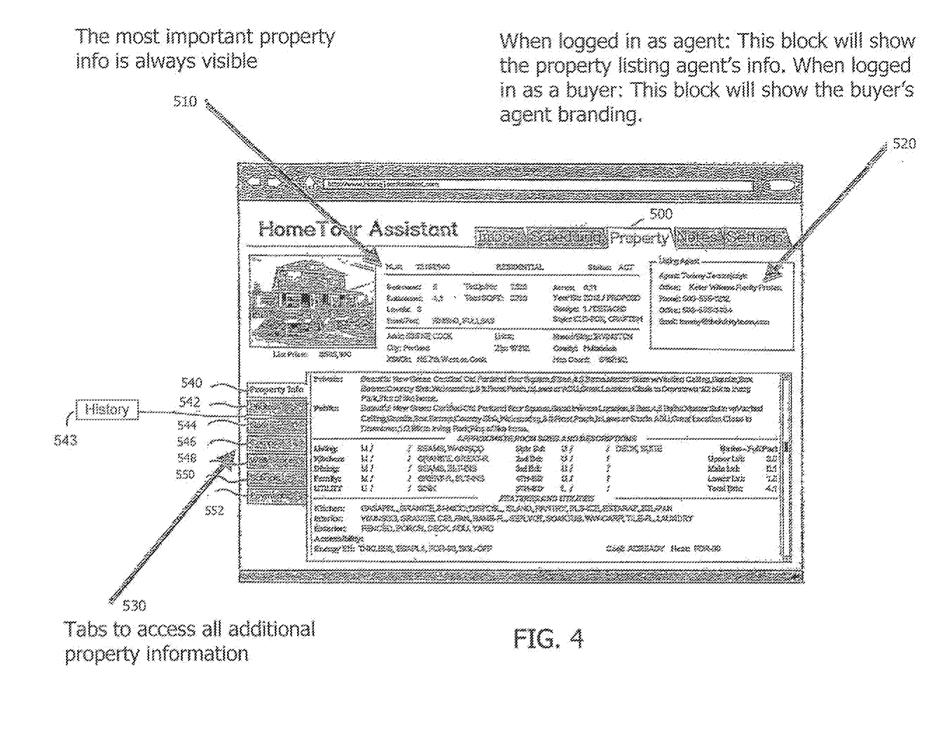

Referring to FIG. 4, the assistant interface may include a property tab 500. The most relevant property information 510 may be presented in a manner that is always visible on a portion of the interface. When being used by the buyer's agent the listing agent information 520 may show the property listing agent's information, so that ready contact may be made, as desired. When being used by the buyer, the listing agent information may include the buyer's agent. Preferably, when the system is used by the home buyer, it would preferably not say “listing agent”. In this manner, depending upon who is logged into the system or otherwise using the system, more appropriate information may be provided. The lower portion of the interface may include additional property information 530. The additional property information, may include for example, property information 540, photos 542, history 543, notes 544, comps 546, walk score 548, schools 550, and/or payments 552. The comps 546 may, for example, show a visual map and/or list of the homes around the subject property that meet a set of pre-determined criteria (such as within ¼ miles, +/−1 bedroom, +/−500 square feet). For example, such properties may be automatically determined, and automatically imported from the MLS system into the tab.

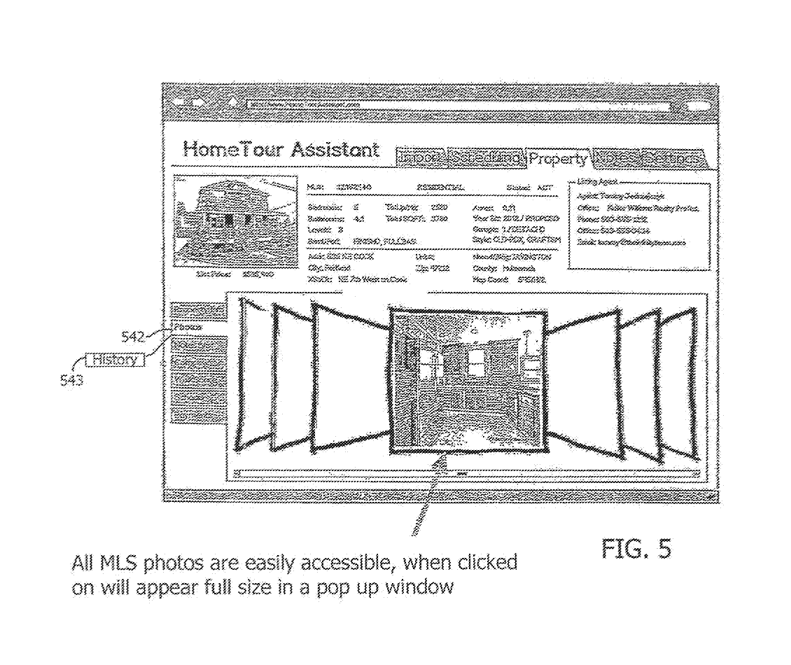

Referring to FIG. 5, the photos 542 may include a plurality of photos of the property. For example, the photographs may be scrolled through in a sequential manner. For example, if a photograph is selected it may be presented in a pop-up window. By way of example, the images may be imported from the MLS system.

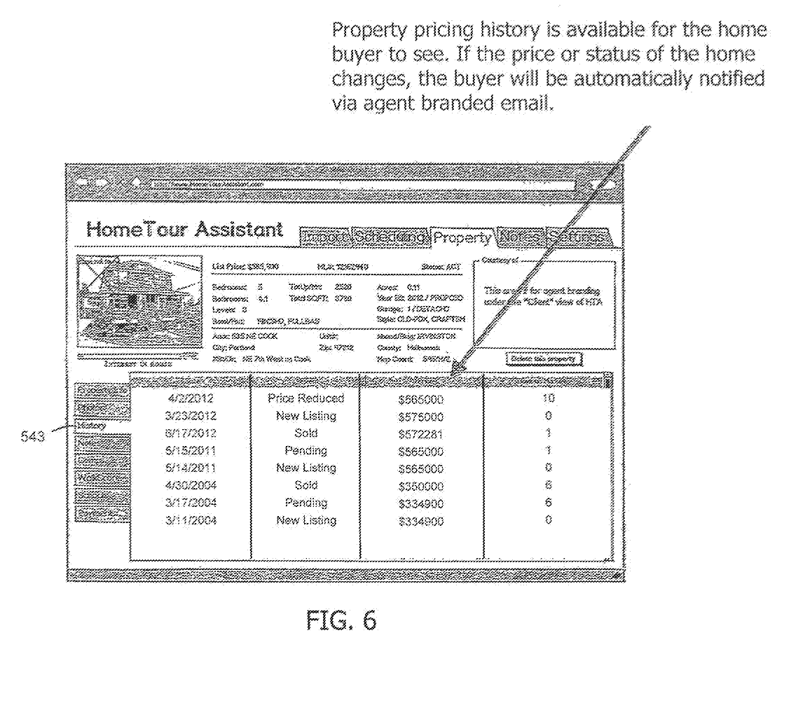

Referring to FIG. 6, the history 543 may include pricing history for the agent and/or buyer to view. If the price and/or status of the home changes, the buyer may be automatically notified, such as using an agent branded e-mail. In this manner, any properties associated with the buyer may automatically trigger an e-mail communication to the buyer when a suitable event occurs, such as a price reduction, new listing, sold, and/or pending.

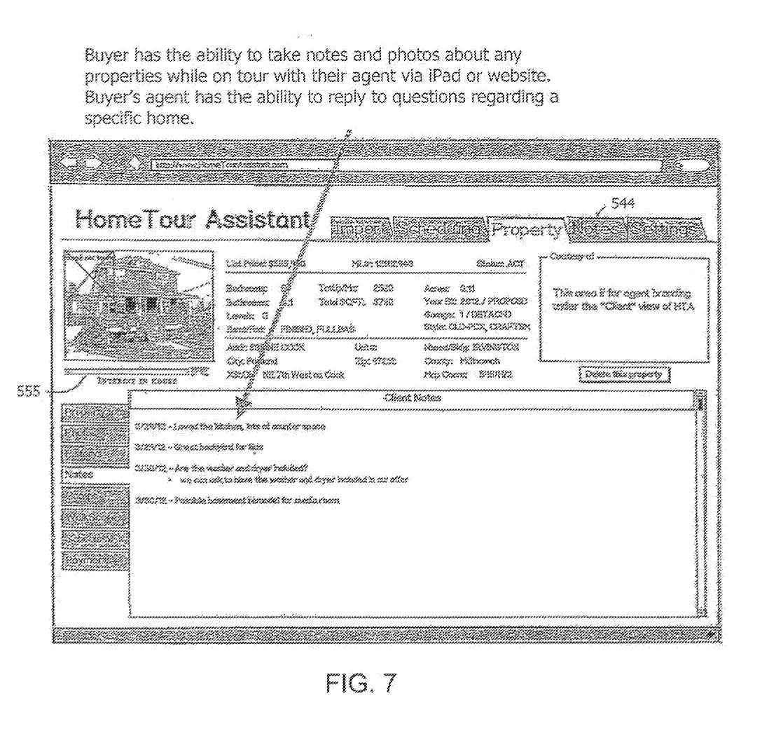

Referring to FIG. 7, the notes 544 section provides an interface for the buyer to take notes and/or photos about the property before, during, or after the viewing of the property. For example, the agent and/or the buyer may include pictures and/or notes in this location. The buyer may post questions regarding a specific home in this, which notifies the agent of the question, and the agent may specifically respond to the buyer in the interface. In this manner, the buyer may communicate specific questions to the agent regarding specific properties. Moreover, the agent can identify additional desires of the buyer by viewing their notes. Further, the home illustrated in FIG. 7 may include a “interest” indicator that may be set by the agent and/or buyer. For example, the buyer may slide the “Interest In House” 555 indicator toward the right to indicate the amount of interest in the property. The agent may observe the buyer's interest in the property by looking at the “Interest In House” slider 555 for each of the properties. The properties for a buyer may be sorted by the interest level, as desired.

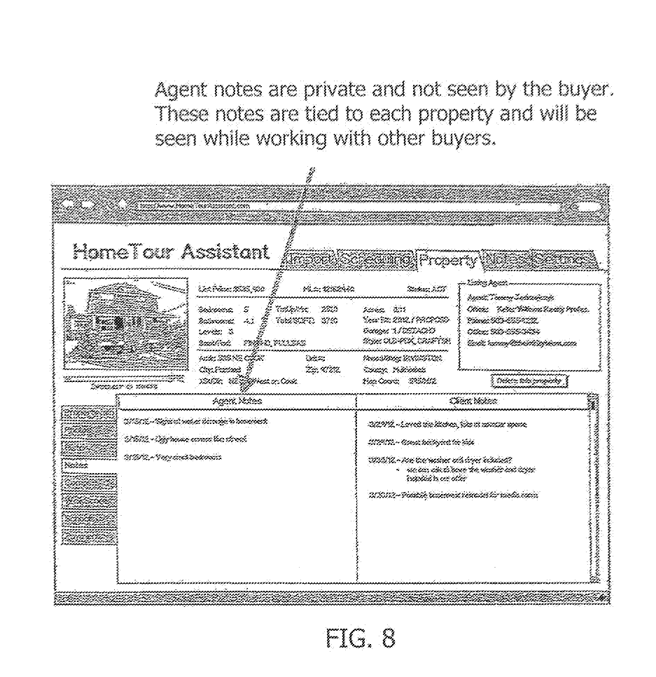

Referring to FIG. 8, the agent may also take notes that are maintained private from the buyer. In this manner, the agent may take notes regarding a property that are likewise available to the agent when the property is likewise part of a virtual tour of another buyer. In addition, the notes may be private to the particular agent, if desired. Also, for a group of agents such as a group of agents of a particular agency, the notes may be automatically and/or selectively shared among the agents. In this manner, all the agents of the group will be made aware of such notes which may provide a competitive advantage over agents not part of such a group.

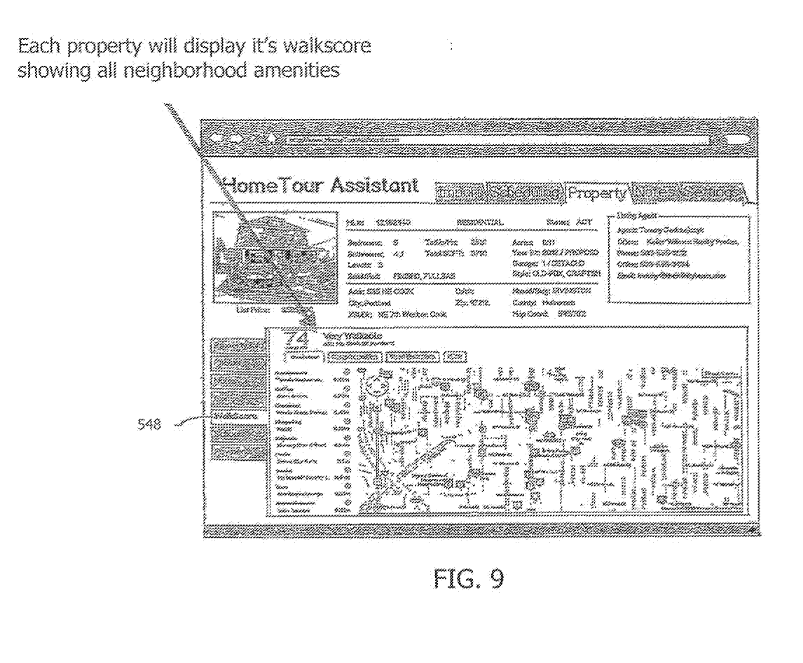

Referring to FIG. 9, the walk score 548 may be selected which provides a graphical viewing of the walkability of the location of the house. This type of information is of importance to some buyers.

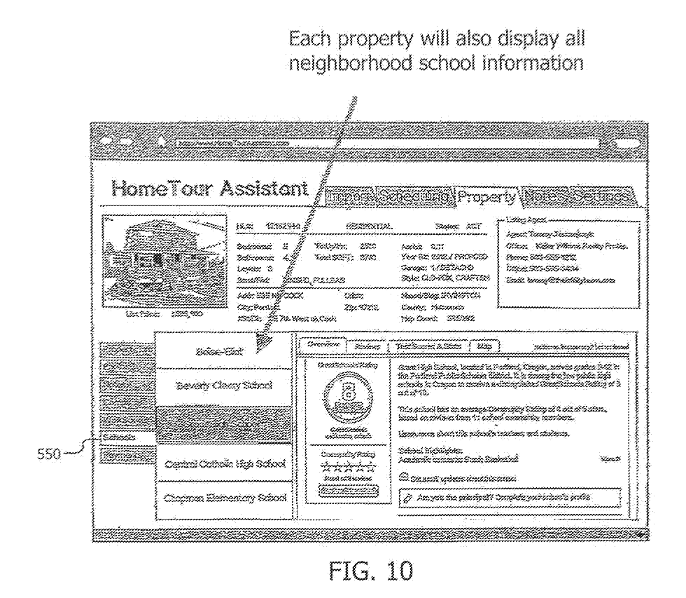

Referring to FIG. 10, the schools 550 may be selected which provides information regarding the schools relevant to the location of the house. This type of information is of importance to some buyers.

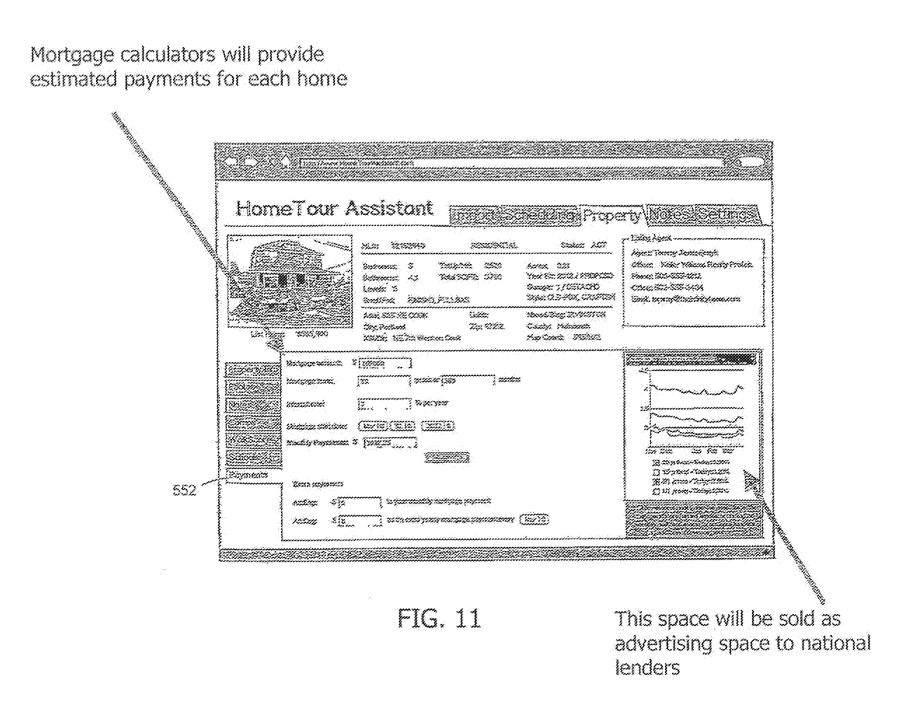

Referring to FIG. 11, the payment 552 may include a payment calculator to estimate the payments for the property. The mortgage amount may be automatically filled in based upon the property listing price. In addition, a portion of the interface may provide advertising for lenders, that may be sold to advertisers.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for presenting real estate information on a display comprising:
(a) presenting an interface including said real estate information on said display; and
(b) importing through said interface an import selection that imports data regarding homes to be displayed on said interface.

2. The method of claim 1 wherein said display is interconnected with a computing device.

3. The method of claim 1 wherein said imported data is obtained from at least two different sources.

4. The method of claim 3 wherein at least one of said sources include a multiple listing service.

5. The method of claim 1 wherein said imported data is obtained from another said interface.

6. The method of claim 1 wherein said imported data includes a picture of a house and a corresponding address for said house.

7. The method of claim 1 wherein said interface includes a listing agent's name and contact information.

8. The method of claim 1 wherein said interface displays time information indicating when one of homes is available for showing.

9. The method of claim 1 wherein said importing includes obtaining said data from another said interface.

10. The method of claim 1 wherein a selection of homes are selected for viewing.

11. The method of claim 10 wherein said selected homes are displayed graphically on a map.

12. The method of claim 11 wherein said selected home are arranged in a viewing order based upon a respective available viewing time and a geographic location of said homes relative to other selected homes.
